(19) United States
(12) Patent Application Publication
(10) Pub. No.: US 2025/0209701 A1
(43) Pub. Date: Jun. 26, 2025

(54) MULTI-STYLE TRANSFORMATION APPARATUS AND METHOD

(71) Applicant: ELECTRONICS AND TELECOMMUNICATIONS RESEARCH INSTITUTE, Daejeon (KR)

(72) Inventors: Bon-Woo HWANG, Daejeon (KR); Ki-Nam KIM, Daejeon (KR); Tae-Joon KIM, Sejong-si (KR); Seung-Uk YOON, Daejeon (KR); Seung-Wook LEE, Daejeon (KR); Seong-Jae LIM, Daejeon (KR)

(73) Assignee: ELECTRONICS AND TELECOMMUNICATIONS RESEARCH INSTITUTE, Daejeon (KR)

(21) Appl. No.: 18/981,829

(22) Filed: Dec. 16, 2024

(30) Foreign Application Priority Data
Dec. 22, 2023 (KR) 10-2023-0189337

(51) Int. Cl. G06T 11/60; G06T 3/40; G06T 7/12; G06T 9/00; G06V 10/774

(52) U.S. Cl. CPC G06T 11/60; G06T 3/40; G06T 7/12; G06T 9/00; G06V 10/774; G06T 2207/20084; G06T 2207/20132

(57) ABSTRACT

Disclosed herein are a multi-style transformation apparatus and method. The multi-style transformation apparatus may include a region segmentation unit configured to segment a region, a style of which is to be transformed, in a content image, a style transformation mask generation unit configured to generate a multi-channel mask for style application to each segmentation region, and a multi-style transformation model implemented as a pre-trained deep neural network in order to receive the content image and the multi-channel mask and output a multi-style transformed image.

### CROSS REFERENCE TO RELATED APPLICATION

This application claims the benefit of Korean Patent Application No. 10-2023-0189337, filed Dec. 22, 2023, which is hereby incorporated by reference in its entirety into this application.

### BACKGROUND OF THE INVENTION

### 1. Technical Field

The following embodiments relate to technology for transforming the style of an input image using an artificial neural network.

### 2. Description of the Related Art

A conventional method of transforming the style of an input image using an artificial neural network is performed to transform the style of an image for a paired dataset, in which input and output correspond to each other, and a non-paired dataset by utilizing an image dataset of an input image style and an image dataset of an output style through an image-to-image transformation network.

In this case, there is a limitation in that multiple input style datasets and output style datasets are required. Especially for paired datasets, there is a disadvantage in that it is not easy to collect different styles of data corresponding to an input style, whereas there is an advantage in that a favorable evaluation may be obtained in terms of the degree of transformation and the quality of transformation. Research into technology for transforming various contributes of an input image, such as gender, hair color, age, and facial expression, by exploiting non-paired data through a single artificial intelligence neural network such as StarGan, has been conducted, wherein the degree of transformation is limited by the specific attributes of specific category data.

In order to overcome the disadvantage of data collection, research into a style transfer method that transfers the style of an input image into the style of a reference image while maintaining the content of an input image uses a given single artificial neural network has been conducted. This method has significant advantages in terms of ease of data collection and not requiring additional training during the style transfer process. However, there is a disadvantageous in that it is impossible to sufficiently extract style information from the given single image and there is quality restriction when the styles of various reference images are applied to the input image through the artificial intelligence neural network.

Further, a deep learning model StyleGan2 used for style transformation (T. Karras, S. Laine, M. Aittala, J. Hellsten, J. Lehtinen, and T. Aila, “Analyzing and improving the image quality of StyleGAN,” In Proc. CVPR, 2020.) or a fully connected network in which a latent vector is smoothened, is disadvantageous in that network architecture is complicated and a computational load is increased compared to a fully convolutional network architecture.

In addition to those disadvantages, existing style transformation is uniformly applied to the entire image region, and it is very difficult to maintain fidelity and quality of style transformation in respective regions while dividing a single output image into specific regions and independently applying various styles to the specific regions of the single output image.

### SUMMARY OF THE INVENTION

An embodiment is intended to provide an apparatus and method that can perform high-quality multi-style transformation on respective regions using a single artificial intelligence network that cannot be provided by conventional image style transformation technology.

In accordance with an aspect of the present disclosure to accomplish the above object, there is provided a multi-style transformation apparatus, including a region segmentation unit configured to segment a region, a style of which is to be transformed, in a content image, a style transformation mask generation unit configured to generate a multi-channel mask for style application to each segmentation region, and a multi-style transformation model implemented as a deep neural network and pre-trained to receive the content image and the multi-channel mask and output a multi-style transformed image.

The multi-style transformation apparatus may further include an image data conversion unit configured to convert a data format of the content image and input the data-format converted content image to an image encoding unit and a region segmentation unit.

The image data conversion unit may convert a size of the content image through an interpolation and sampling technique, convert integer-type data into real number-type data, and normalize a data range to a value falling within a certain range using average and variance.

The region segmentation unit may be configured to output segmentation region information in a form of at least one of multiple masks, a multi-channel mask, or an RGBA color image, or a combination thereof, and set styles for respective segmentation regions according to a user's intention.

The multi-style transformation apparatus may further include a style intensity adjustment unit configured to set style application intensities for respective segmentation regions, wherein the style transformation mask generation unit may generate the multi-channel mask based on the segmentation regions and style application intensities for respective segmentation regions.

Here, the style intensity adjustment unit may set style application intensities for respective segmentation regions by receiving the style application intensities from a user, or may set the style application intensities for respective segmentation regions depending on predefined mapping values for respective object components.

The style transformation mask generation unit is configured to generate a multi-channel mask which has a size identical to a size of the content image and in which a value of a channel corresponding to an index of a style set to be applied to each segmentation region is set to ‘1’ and values of remaining channels are set to ‘0’, and to set all channels of segmentation regions that are set for non-transformation to ‘0’.

The multi-style transformation model may include an image encoding unit configured to receive the content image and the mask, concatenate the content image and the mask along a channel axis, and then generate a latent image based on a pre-trained deep neural network, and an image decoding unit configured to receive the latent image and generate a style-transformed image based on the pre-trained deep neural network.

In accordance with an aspect of the present disclosure to accomplish the above object, there is provided a multi-style transformation method, including segmenting a region, a style of which is to be transformed, in a content image, generating a multi-channel mask for style application to respective segmentation regions, and receiving the content image and the multi-channel mask and outputting a multi-style transformed image based on a pre-trained multi-style transformation model implemented as a deep neural network.

The multi-style transformation method may further include converting a data format of the content image, wherein segmenting and generating a latent image may be performed on the converted content image.

Converting the data format may include converting a size of the content image through an interpolation and sampling technique, converting integer-type data into real number-type data, or normalizing a data range to a value falling within a certain range using average and variance.

Segmenting the region may include outputting segmentation region information in a form of at least one of multiple masks, a multi-channel mask or an RGBA color image, or a combination thereof, and setting styles for respective segmentation regions according to a user's intention.

The multi-style transformation method may further include setting style intensities to set style application intensities for respective segmentation regions, and generating the mask may include generating the multi-channel mask based on the segmentation regions and style application intensities for respective segmentation regions.

Here, setting the style intensities may include setting the style application intensities for respective segmentation regions by receiving the style application intensities from a user, or setting the style application intensities depending on predefined mapping values for respective object components.

Generating the mask may include generating a multi-channel mask which has a size identical to a size of the content image and in which a value of a channel corresponding to an index of a style set to be applied to each segmentation region is set to ‘1’ and values of remaining channels are set to ‘0’, and setting all channels of segmentation regions that are set for non-transformation to ‘0’.

The multi-style transformation model may include an image encoding unit configured to receive the content image and the mask, concatenate the content image and the mask along a channel axis, and then generate a latent image based on a pre-trained deep neural network, and an image decoding unit configured to receive the latent image and generate a style-transformed image based on the pre-trained deep neural network.

In accordance with an aspect of the present disclosure to accomplish the above object, there is provided a multi-style transformation training apparatus, including a training image database configured to store indexed content-style image dataset pairs, a training data generation unit configured to generate a content patch and a style patch by selecting a content-style image dataset pair from the training image database, a style transformation mask generation unit configured to generate a multi-channel mask using an index of the selected content-style image dataset pair, a multi-style transformation model implemented as a deep neural network and configured to receive a content image and the multi-channel mask and output a multi-style transformed image, and a style transformation error analysis unit configured to analyze error between a multi-style-transformed patch generated by the multi-style transformation model and the style patch generated by the training data generation unit, wherein the multi-style transformation model is trained to minimize error analyzed by the style transformation error analysis unit.

The training data generation unit may be configured to perform at least one of normalization or image augmentation, or a combination thereof to a value falling within a specific range on each of a content image and a style image of the content-style image dataset pair selected from the training image database, and thereafter generate a content patch and a style patch by cropping a resulting image in a certain size.

A mask image may have a size identical to a size of the content patch and includes the number of channels identical to the number (N) of style indices corresponding to content-style image dataset pairs present in the training image database, and the style transformation mask generation unit may generate a mask in which a value of a channel corresponding to an index (n, n=0, . . . , N−1) of the selected content-style image dataset pair is set to ‘1’, and in which values of remaining channels are set to ‘0’.

The training data generation unit may copy the content patch instead of a style patch depending on a specific probability defined as a non-transformation probability, and set index information of the content-style image dataset pair to specific code other than n, and the style transformation mask generation unit may set all channels of a style transformation mask to ‘0’ when the index of the content-style image dataset pair is set to the specific code other than n.

The multi-style transformation model may include an image encoding unit configured to receive the content patch and the mask, concatenate the content patch and the mask along a channel axis, and then generate a latent image based on the deep neural network, and an image decoding unit configured to receive the latent image and generate a style-transformed image based on the deep neural network.

The multi-style transformation training apparatus may further include an multi-resolution image conversion unit configured to generate multi-resolution images, horizontal and vertical sizes of which are reduced at certain rates by applying a down-sampling or image interpolation technique to the style patch generated by the training data generation unit, wherein the image decoding unit receives an encoded latent image and further generates and outputs a multi-resolution feature map, and wherein the style transformation error analysis unit calculates encoding image error through a weighted sum of errors between multi-resolution images received from the multi-resolution image conversion unit and the multi-resolution feature map received from the image decoding unit.

The image decoding unit may receive an encoded latent image and further generate and output a restored mask, and the style transformation error analysis unit may analyze error between the style patch and the style-transformed image output from the image decoding unit.

The style transformation error analysis unit may analyze error between the mask received from the style transformation mask generation unit and a mask restored by the image decoding unit.

The style transformation error analysis unit may calculate generative adversarial error by inputting a style-transformed image output from the image decoding unit to a discriminator in a generative adversarial error analysis unit.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic block configuration diagram of a multi-style transformation apparatus according to an embodiment;

FIGS. 2 to 7 are diagrams illustrating examples of multi-style transformation according to an embodiment;

FIG. 8 is a schematic block configuration diagram of a multi-style transformation training apparatus according to an embodiment;

FIG. 9 is a configuration diagram of a training image database according to an embodiment;

FIG. 10 is a block diagram illustrating the internal configuration of a style error analysis unit according to an embodiment;

FIG. 11 is a flowchart of a multi-style transformation method according to an embodiment; and

FIG. 12 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

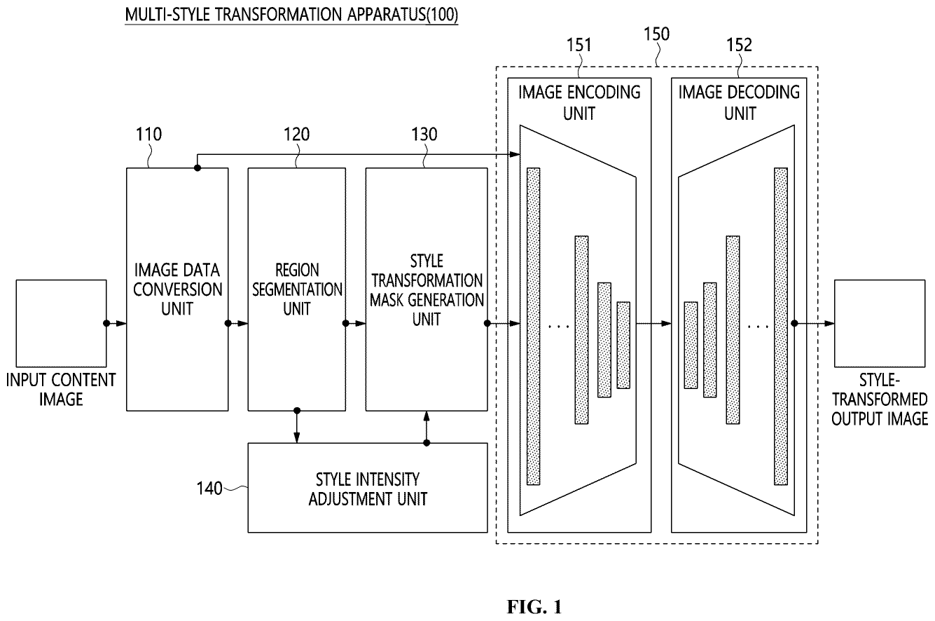

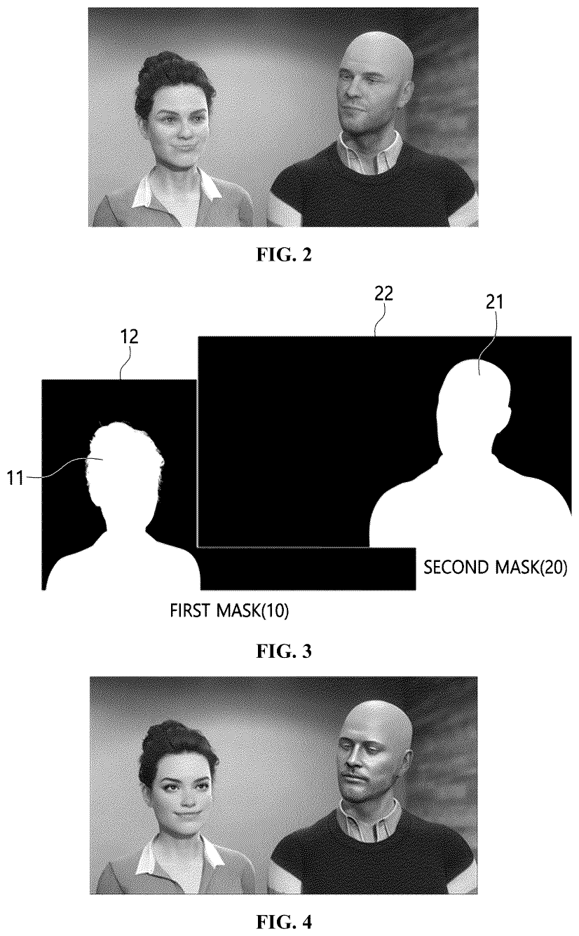

FIG. 1 is a schematic block configuration diagram of a multi-style transformation apparatus according to an embodiment, and FIGS. 2 to 7 are diagrams illustrating examples of multi-style transformation according to an embodiment.

Referring to FIG. 1, a multi-style transformation apparatus 100 according to an embodiment may output a style-transformed image having different styles with respect to image content depending on the regions of the image content.

For this operation, the multi-style transformation apparatus 100 according to an embodiment may include a region segmentation unit 120, a style transformation mask generation unit 130, and a multi-style transformation model 150. In addition, the multi-style transformation apparatus 100 may include an image data conversion unit 110 and a style intensity adjustment unit 140.

The image data conversion unit 110 may convert the image data format of a content image to suit the region segmentation unit 120 and the multi-style transformation model 150.

Here, the image data conversion unit 110 may convert the size of the content image through an interpolation and sampling technique, convert integer-type data into real number-type data, and normalize the data range of the content image into a value falling within a certain range using average and variance.

Here, the data range may be, for example, a range of 0 to 255. Further, the certain normalized range may be a range of 0 to 1 or a range of −1 to 1.

The region segmentation unit 120 may generate segmentation region information by segmenting a region, the style of which is to be transformed, in the content image.

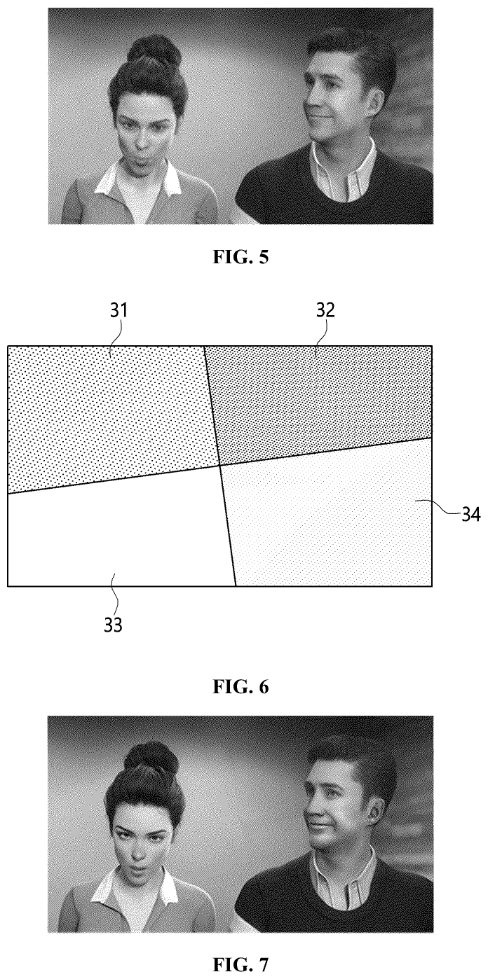

Here, the region segmentation unit 120 may segment the style transformation target region of the content image into sub-regions for respective objects, respective object components, or respective regions. For example, the style transformation target region may be segmented depending on the position of a person who is the object of a content image generated by rendering a three-dimensional (3D) human body, as illustrated in FIG. 2, using computer graphics. Alternatively, the style transformation target region may be segmented for respective objects included in the content image generated by rendering the 3D human body illustrated in FIG. 5 using computer graphics, depending on partial components.

For this, the region segmentation unit 120 may include a separate object segmentation unit or a separate object component segmentation unit to automatically segment the corresponding region, or may segment the corresponding region in response to request information input by a user through a Graphics User Interface (GUI).

Here, the region segmentation information may be output in the form of at least one of multiple masks, a multi-channel mask, or an RGBA color image or a combination thereof. Further, styles for respective segmentation regions may be set according to the user's intention.

For example, as shown in FIG. 3, when the segmentation information format is the format of multiple masks, a white region 11 of a first mask image 10 between two mask images 10 and 20 may indicate a 3D animation style region, and a white region 21 of a second mask image 20 may indicate a copper statue style region. Further, in the two mask images 10 and 20, black regions 12 and 22 may be style non-transformation regions, and may be regions in which the style of an input content image is maintained without change.

For example, when the segmentation information format is a multi-channel mask, the first channel of the mask may be an oil painting style and the second channel of the mask may be a 3D animation style.

For example, as shown in FIG. 6, when the segmentation information format is an RGBA color image, a blue region 31 may set to a 2D animation style region, a red region 32 may be set to an oil painting region, an alpha (white) region 33 may be set to a 3D animation style region, and a green region 34 may be set to a copper statue style region.

However, this segmentation information format is only an example, and the present disclosure is not limited thereto. That is, segmentation information may be generated through various formats according to embodiments.

The style transformation mask generation unit 130 may generate a multi-channel mask configured as multiple channels for application of styles to respective segmentation regions.

Here, such a multi-channel mask may be generated at the same size as the content image.

Here, the style transformation mask generation unit 130 may generate a multi-channel mask for which the value of a channel corresponding to the index of style set to be applied to each segmentation region is set to ‘1’, and the values of the remaining channels are set to ‘0’.

Also, the style transformation mask generation unit 130 may set all channels of segmentation regions set for non-transformation to ‘0’.

The style intensity adjustment unit 140 may set the style application intensity for each segmentation region.

Here, the style intensity adjustment unit 140 may set the style application intensities for respective segmentation regions by receiving the intensities from a GUI user, or may set the style application intensities for respective segmentation regions depending on mapping values for respective predefined object components.

For example, the value of the style application intensity, corresponding to ‘0’, may mean that the style of the input content is maintained without change, the value of ‘0.5’ may mean an intermediate degree between the input content and a transformation style, and ‘1’ may indicate that the transformation style is applied to the maximum extent.

Therefore, background may be set to ‘0’, hair may be set to ‘0.5’, a skin area may be set to ‘1’, and a clothes area may be set to ‘0.7’.

Therefore, the style transformation mask generation unit 130 may generate a multi-channel mask by further considering style application intensity for each segmentation region, set by the style intensity adjustment unit 140, in addition to the style information for each segmentation region.

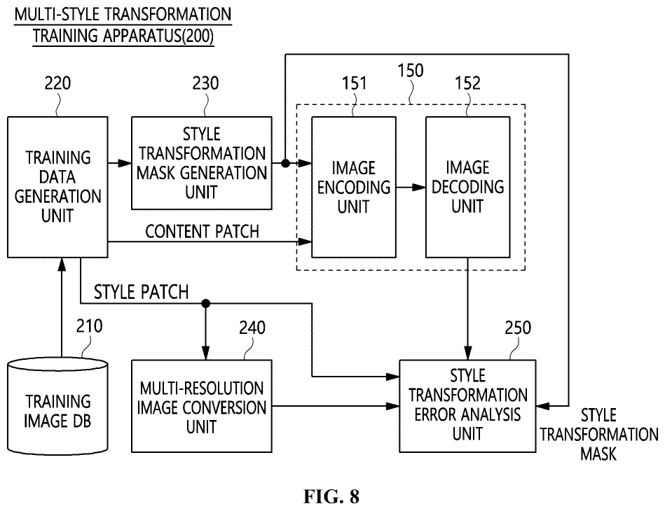

The style transformation mask generation unit 130 may output a multi-channel mask having the same size as the input content image in the format identical to that of a style transformation mask generation unit 230 included in the multi-style transformation training apparatus 200, which will be described later with reference to FIG. 8.

The multi-style transformation model 150 may be implemented as a deep neural network, and may be a model pre-trained to receive a content image and a mask and output a multi-style transformed image. Such a training apparatus 200 for training the multi-style transformation model 150 will be described in detail later with reference to FIGS. 8 to 10.

In detail, the multi-style transformation model 150 may include an image encoding unit 151 which receives a content image and a mask to concatenate the content image and the mask along a channel axis and generates a latent image based on a pre-trained deep neural network, and an image decoding unit 152 which receives the latent image and generates a style-transformed image based on the pre-trained deep neural network.

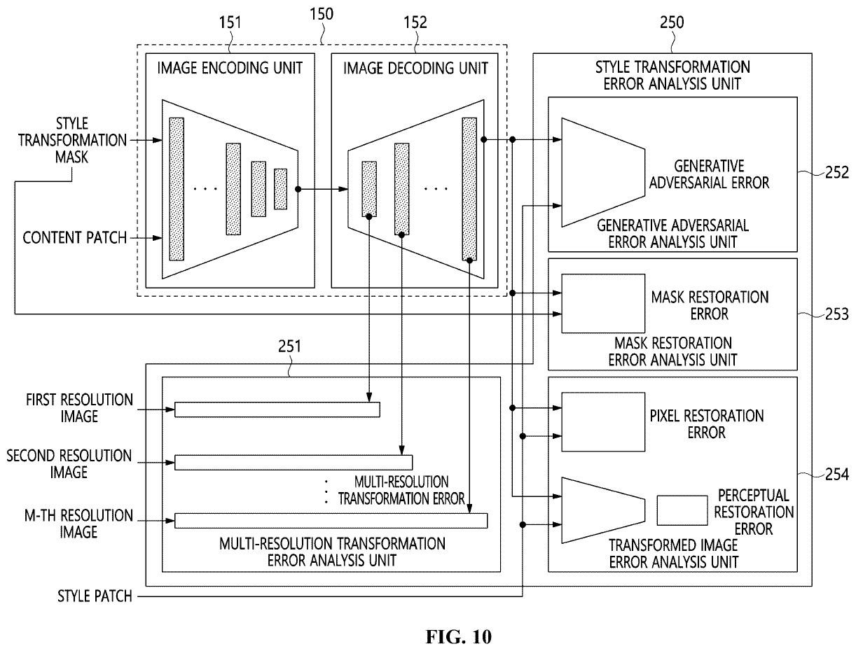

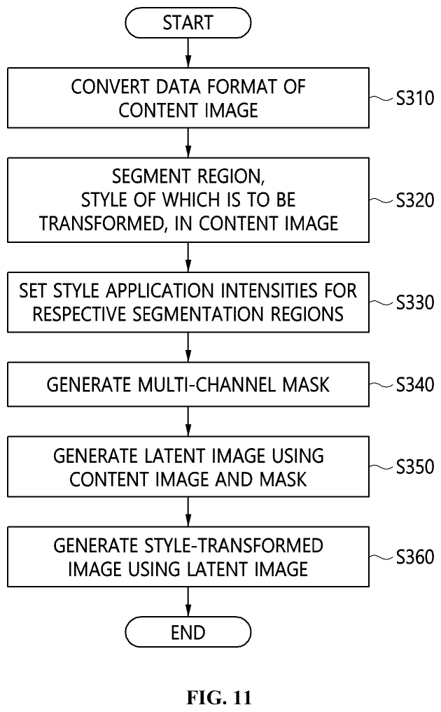

The image encoding unit 151 and the image decoding unit 152 may have the same neural network architecture as the image encoding unit 151 and the image decoding unit 152, which will be described later with reference to FIGS. 8 and 10, and may generate a style-transformed image using the finally updated weight in the state in which the training is completed by the multi-style transformation training apparatus 200.

However, the image decoding unit 152 illustrated in FIG. 1 may reduce a computational load by generating only a style-transformed image and skipping the generation of a multi-resolution feature map and a mask, unlike the image decoding unit 152, which will be described later with reference to FIGS. 8 and 10, and which generates a style-transformed image, a multi-resolution feature map, and a mask image.

By the above-described multi-style transformation apparatus 100, various output images in which various styles are applied to one content image may be generated.

For example, a multi-channel mask having segmentation region information such as that illustrated in FIG. 3 is applied to the content image such as that illustrated in FIG. 2, and thus an output image including a 3D animation style region, a copper statue style region, and a style non-application region for respective objects may be output, as shown in FIG. 4.

Further, a multi-channel mask having segmentation region information such as that illustrated in FIG. 6 is applied to the content image such as that illustrated in FIG. 5, and thus an output image including a 2D animation style region, an oil painting region, a 3D animation style region, and a copper statue style region may be output, as shown in FIG. 7.

Here, FIGS. 2 and 7 show only examples of the present disclosure, and the present disclosure is not limited thereto. That is, the application target and region may be applied to the entire body area, and in addition to face or body areas, other objects for example, animals such as a dog or a cat, other pieces of furniture, and vehicles may be the target region. Further, application styles may be, but are not limited to, the oil painting style, the 2D animation style, the 3D animation style, the copper statue style, or a realistic photo.

As described above, the multi-style transformation apparatus 100 according to the embodiment may promptly and easily transform multiple styles through a single deep neural network.

That is, a conventional image-to-image style transformation scheme may independently train a style transformation deep neural network for respective styles, may apply weights for respective styles trained during inference, to the image encoding unit and the image decoding unit, may obtain respective multiple style transformed images for the input content image, and may combine the multiple style transformed images with each other by applying a style transformation mask to the multiple style transformed images, thus obtaining multi-style transformation results. However, a method using multiple independent style transformation inference devices requires additional computation for a number of style transformation operations and combination identical to the number of application styles, and thus the conventional scheme is very inefficient compared to the multi-style transformation apparatus 100 according to the present disclosure.

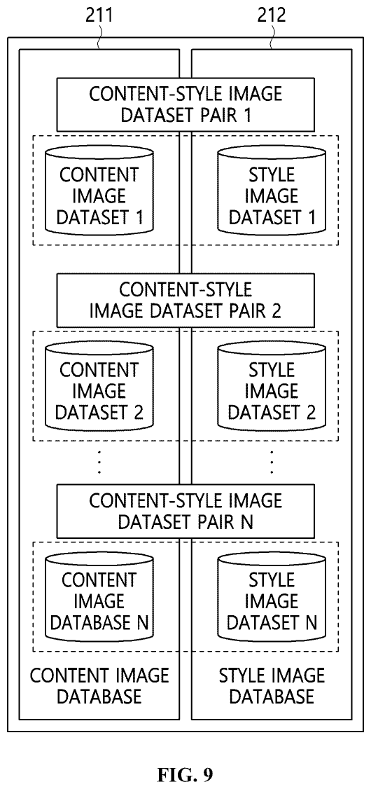

FIG. 8 is a schematic block configuration diagram of a multi-style transformation training apparatus according to an embodiment, FIG. 9 is a configuration diagram of a training image database according to an embodiment, and FIG. 10 is a block diagram illustrating the internal configuration of a style error analysis unit according to an embodiment.

Referring to FIG. 8, the multi-style transformation training apparatus 200 according to an embodiment may broadly include a training image database 210, a training data generation unit 220, a style transformation mask generation unit 230, a multi-style transformation model 150, and a style transformation error analysis unit 250. In addition, the multi-style transformation training apparatus 200 may further include a multi-resolution image conversion unit 240.

The training image database (DB) 210 may store indexed content-style image dataset pairs.

That is, referring to FIG. 9, the training image DB 210 may include content image datasets 211 and style image datasets 212. The content image datasets 211 may be composed of realistic photo images and various content images of a single style, such as 3D rendered images using a specific shader. The style image datasets 212 are configured such that images which have the same content as images in the respective content image datasets and which have different styles such as oil painting style, a copper statue style, a 2D animation style, and a 3D animation style, are classified and distinguished for respective styles and are stored in physical media such as a hard disk or a cloud-type network platform.

Here, N content image datasets 211 may form pairs with N style image dataset 212 corresponding thereto.

However, the content image datasets may overlap the style image datasets in a 1: N format. That is, multiple style image datasets corresponding to the same content image may exist for each style

Referring back to FIG. 8, the training data generation unit 220 may generate a content patch and a style patch by selecting a content-style image dataset pair from the training image DB 210.

Here, the training data generation unit 220 may perform at least one of normalization or image augmentation, or a combination thereof using a value falling within a specific range on a content image and a style image in the content-style image dataset pair selected from the training image database 210, and thereafter generate a content patch and a style patch by cropping the resulting image in a certain size.

That is, each of content-style image dataset pairs sequentially or randomly selected from the training image DB 210 during a training process may be normalized to values within a specific range of 0 to 1 or of −1 to 1.

Here, as image augmentation, geometric augmentation, color augmentation, noise addition or the like may be performed.

Further, the training data generation unit 220 may output index information n (n=0, . . . , N−1) of the selected content-style image dataset pairs.

Meanwhile, the training data generation unit 220 may copy the content patch instead of the style patch depending on a specific probability defined as a non-conversion probability, and may allocate the index information of each content-style image dataset pair as specific code, for example, ‘-1’ or ‘9999’ other than n.

Such a process of copying the content patch instead of the style patch depending on the non-transformation probability and allocating the specific index (e.g., ‘-1’ or ‘9999’) is intended to perform training so that an input content style maintenance function of preventing style transformation from being performed on a specific image or a specific region during a style transformation inference process is added. This process may be selectively used according to the circumstance, and may be skipped by setting a non-transformation probability to ‘0’ when style transformation is performed on all images or all regions and a style non-transformation function is not necessary.

A detailed algorithm for selecting the above-described content-style image dataset pair and a method of setting a non-transformation probability value used in a training process fall out of the scope of the present disclosure, and thus detailed description thereof will be omitted.

The style transformation mask generation unit 230 may generate a multi-channel mask by using the index of the selected content-style image dataset pair.

Here, the mask image may have the same size as the content patch, and may have the number of channels identical to the number N of style indices corresponding to content-style image dataset pairs in the training image DB.

Here, the style transformation mask generation unit 230 may generate a mask for which the value of a channel corresponding to the index n of the selected content-style image dataset pair is set to ‘1’, and the value of the remaining channels is set to ‘0’.

Also, the style transformation mask generation unit 230 may set all channels of the style transformation mask to ‘0’ when the index of a content-style image dataset pair is set to a specific code (e.g., ‘-1’ or ‘9999’) other than n.

A conventional mask usage method [Wayne2019] is intended to designate the style extraction region of a style image, but the style transformation mask generation unit 230 according to an embodiment is used to designate the style transformation region of the content image and a style to be applied. The present disclosure is different from the existing scheme in terms of the usage purpose and scheme.

The multi-resolution image conversion unit 240 may transform the style patch into a multi-resolution image through down-sampling of the style patch.

That is, the multi-resolution image in which the horizontal and vertical sizes of the style patch received from the training data generation unit 220 are reduced to ½, ¼ or ⅛, etc. is generated using down-sampling or an image interpolation technique.

Here, a size reduction rate, the number of images, and a detailed image transformation algorithm used in the generation of a multi-resolution image may be changed depending on the structure of the image decoding unit 151 or the like, and this falls out of the scope of the present disclosure, and thus detailed descriptions thereof will be omitted.

The multi-style transformation model 150 is implemented using a deep neural network, and may receive the content image and the multi-channel mask, and then output a multi-style transformed image. The multi-style transformation model 150 may be trained to minimize errors analyzed by the style transformation error analysis unit 250.

Here, the multi-style transformation model 150 may include the image encoding unit 151 which receives a content patch and a mask to concatenate the content patch and the mask along a channel axis and generates a latent image based on a deep neural network, and the image decoding unit 152 which receives the latent image and generates a style-transformed image based on the deep neural network.

Here, the image decoding unit 152 may receive an encoded latent image and further generate and output a multi-resolution feature map. The multi-resolution feature map may be used for a multi-resolution restoration error calculation.

Here, the image decoding unit 152 may receive the encoded latent image and further generate and output a restored mask. The restored mask may be used for mask restoration error analysis.

Meanwhile, each of the image encoding unit 151 and the image decoding unit 152 may be implemented as a deep neural network including a normalization layer, a convolutional layer, an activation function layer, etc.

That is, the image encoding unit 151 and the image decoding unit 152 may be implemented using a deep neural network having an enhanced model structure such as an end-to-end type fully convolutional layer-based model chiefly used for image segmentation or the like, that is, U-Net (O. Ronneberger, P. Fischer, and T. Brox, “U-net: Convolutional networks for biomedical image segmentation,” in Proc. Int. Conf. Medical Image Comput. Comput.-Assisted Intervention, 2015.) and UNet++ (Z. Zhou, M. R. Siddiquee, N. Tajbakhsh, J. Liang, “UNet++: A Nested U-Net Architecture for Medical Image Segmentation”, Lecture Notes in Computer Science, Vol. 11045, 2018.). Further, according to the processing scheme, the image encoding unit 151 and the image decoding unit 152 may be combined with each other and replaced with an image encoding/decoding unit. Furthermore, a detailed structure of the neural network of the image encoding unit 151 is not intended to limit the present disclosure, and may be replaced with a neural network having another structure having the same function.

The style transformation error analysis unit 250 may calculate an error so as to train and optimize the deep neural network of the multi-style transformation model 150.

The style transformation error analysis unit 250 according to an embodiment may analyze at least one of multi-resolution transformation error, generative adversarial error, mask restoration error, pixel restoration error, and perceptual restoration error.

In detail, referring to FIG. 10, the style transformation error analysis unit 250 may include a multi-resolution transformation error analysis unit 251, a generative adversarial error analysis unit 252, a mask restoration error analysis unit 253, and a transformed image error analysis unit 254.

Here, the multi-resolution conversion error analysis unit 251 may calculate an encoded image error through the weighted sum of errors between the multi-resolution images received from the multi-resolution image conversion unit 240 and the multi-resolution feature map received from the image decoding unit 152.

That is, based on the resolution feature map, errors are obtained using distance equations such as L1 Norm or L2 Norm for respective resolutions, and an encoded image error is calculated through the weighted sum of the errors. Here, multi-resolution images received from the multi-resolution image conversion unit function as a ground truth. The multi-resolution conversion error analysis unit 251 may contribute to the rapid convergence of the image decoding unit 152 during an initial training process.

Here, the generative adversarial error analysis unit 252 may generate generative adversarial error by inputting the style-transformed image output from the image decoding unit 152 to a discriminator provided in the generative adversarial error analysis unit 252.

That is, an adversarial neural network structure implemented as the discriminator is provided in the generative adversarial error analysis unit by utilizing the image decoding unit 152 as a generator. In order to train the discriminator in the generative adversarial error analysis unit, the discriminator may be trained by setting the style patch from the training data generation unit 220 as a true value and setting the style-transformed image from the image decoding unit 152 as a false value.

The mask restoration error analysis unit 253 may analyze error between the mask generated by the style transformation mask generation unit 230 and the mask restored by the image decoding unit 152.

The transformed image error analysis unit 254 may receive the style patch generated by the training data generation unit 220 and the style-transformed image generated by the image decoding unit 152, calculate the error between them using a distance equation for each pixel, determine the average of these errors, and then obtain the pixel restoration error.

Also, a feature vector between the style patch from the training data generation unit 220 and the style-transformed image from the image decoding unit 142 may be obtained by utilizing a pre-trained object recognition neural network as a feature extractor, and average error may be calculated by applying a distance equation such as L1 Norm or L2 Norm to the feature vector, and thus perceptual restoration error may be obtained.

In this case, as a deep neural network used for perceptual restoration error analysis in the transformed image error analysis unit 254, a pre-trained model parameter is used without change, and is excluded from an optimization process in such a way that the model parameter is not updated during a training process.

According to an embodiment, the multi-resolution conversion error analysis unit 251, the generative adversarial error analysis unit 252, the mask restoration error analysis unit 253, and the transformed image error analysis unit 254 may be simultaneously used, or alternatively only some thereof may be selectively used. Various modifications of implementation may be regarded as being included in the scope of the present disclosure.

The multi-style transformation apparatus used in the present disclosure chiefly has differences in terms of two elements from the conventional style transfer method such as Style Transfer (J. Wang, C.-Y. Lin, “Style transfer,” PCT/US2020/016309, 2020.), ST-VAE (Z.-S. Liu, V. Kalogeiton and M.-P. Cani, “Multiple Style Transfer Via Variational Autoencoder,” 2021 IEEE International Conference on Image Processing (ICIP), Anchorage, AK, USA, pp. 2413-2417, 2021.).

First, the conventional style transfer method extracts style information from individual style images, whereas the present disclosure explicitly transfers style information to the image encoding unit through the mask of the style transformation mask generation unit. This explicit information transfer is advantageous in that style information of a dataset having the same style may be more effectively trained than the conventional method.

Second, conventional ST-VAE or the like may effectively encode the output of an encoding unit having various styles into a latent vector through flattening and a fully-connected layer. The present disclosure may adopt a scheme for encoding the latent image in which spatial information is maintained through a fully convolutional layer instead of latent vector encoding in the conventional scheme. Generally, unlike conventional methods such as ST-VAE that use fully connected layers, a neural network using only fully convolutional layers may ensure that local region information of an image does not affect the generation of the entire image, and may configure all layers of the neural network as fully convolutional layers, thus providing the advantage of freely performing style transformation without being limited by the size of the input image. Further, because the conventional style transfer method is based on StyleGan2 or variational autoencoder, implementation and training are complicated. However, the present disclosure may directly perform style transformation through an image-to-image conversion deep neural network structure by utilizing paired datasets. A supervised learning scheme using paired datasets may provide the result with high-level style transformation quality at the same level as the style transformation of training data.

FIG. 11 is a flowchart illustrating a multi-style transformation method according to an embodiment.

Referring to FIG. 11, the multi-style transformation method according to the embodiment may include step S320 of segmenting a region, the style of which is to be transformed, in a content image, step S340 of generating a mask configured as a multi-channel mask so as to apply styles to respective segmentation regions, and steps S350 and S360 of receiving the content image and the multi-channel mask and outputting a multi-style transformed image based on a pre-trained style transformation model implemented using a deep neural network.

Here, the multi-style transformation method may further include step S310 of converting the data format of the content image, wherein segmentation step S320 and step S350 of generating a latent image may be performed on the transformed content image.

Here, converting step S310 may include converting the size of the content image through an interpolation and sampling technique, converting integer-type data into a real number-type data, and normalizing the data range of the content image into a value falling within a certain range using average and variance.

Here, segmentation step S320 may include outputting segmentation region information in the form of at least one of multiple masks, a multi-channel mask, or an RGBA color image or a combination thereof, wherein styles for respective segmentation regions may be set according to the user's intention.

Here, the multi-style transformation method according to the embodiment may further include step S330 of setting style intensity to set style application intensities for respective segmentation regions. Here, step S340 of generating the mask may include generating a multi-channel mask based on segmentation regions and style application intensities for respective segmentation regions.

Here, setting step S340 may include setting the style application intensities either by receiving style application intensities for respective segmentation regions from the user, or depending on mapping values for respective predefined object components.

Here, step S340 of generating the mask may include generating a multi-channel mask which has the same size as a content image and in which the value of a channel corresponding to the index of the style set to be applied to each segmentation region is set to ‘1’ and the values of the remaining channels are set to ‘0’, wherein, all channels of segmentation regions set for non-transformation may be set to ‘0’.

In this case, steps S350 and S360 of outputting the multi-style transformed image based on the multi-style transformation model may include step S350 of receiving the content image and the mask to concatenate the content image and the mask along a channel axis and generating a latent image based on the pre-trained deep neural network, and step S360 of receiving the latent image and generating a style-transformed image based on the pre-trained deep neural network.

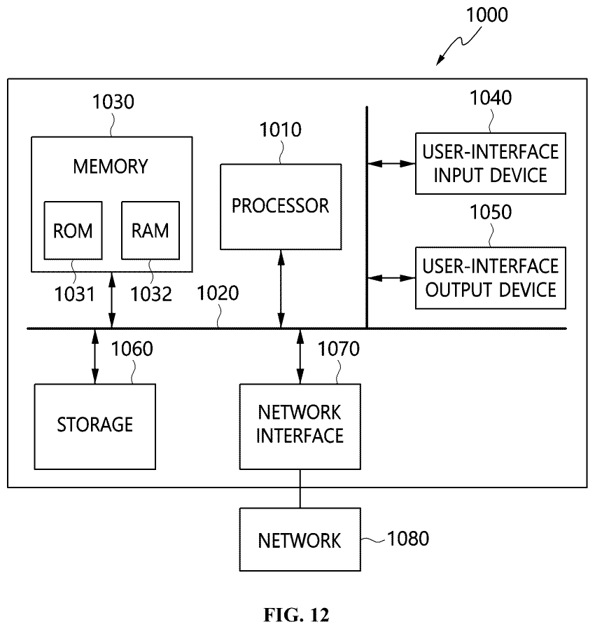

FIG. 12 is a diagram illustrating the configuration of a computer system according to an embodiment.

At least one of a multi-style transformation apparatus 100 according to an embodiment, components of the multi-style transformation apparatus 100, a multi-style transformation training apparatus 200, and components of the multi-style transformation training apparatus 200 may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

According to the embodiments, there is an advantage in that various styles of high-quality style-transformed images that match a user's intention can be generated from an input image or video by applying a multi-style transformation deep neural network training and inference method to the input image or video.

Although the embodiments of the present disclosure have been disclosed, those skilled in the art will appreciate that the present disclosure can be implemented as other concrete forms, without departing from the scope and spirit of the disclosure as disclosed in the accompanying claims. Therefore, it should be understood that the exemplary embodiment is only for illustrative purpose and do not limit the bounds of the present disclosure.

What is claimed is:

1. A multi-style transformation apparatus, comprising:
a region segmentation unit configured to segment a region, a style of which is to be transformed, in a content image;
a style transformation mask generation unit configured to generate a multi-channel mask for style application to each segmentation region; and
a multi-style transformation model implemented as a deep neural network and pre-trained to receive the content image and the multi-channel mask and output a multi-style transformed image.

2. The multi-style transformation apparatus of claim 1, further comprising:
an image data conversion unit configured to convert a data format of the content image by converting a size of the content image through an interpolation and sampling technique, converting integer-type data into real number-type data, and normalizing a data range to a value falling within a certain range using average and variance, and thereafter input a data format-converted content image to the multi-style transformation model and the region segmentation unit.

3. The multi-style transformation apparatus of claim 1, wherein the region segmentation unit is configured to:
output segmentation region information in a form of at least one of multiple masks, a multi-channel mask, or an RGBA color image, or a combination thereof, and
set styles for respective segmentation regions according to a user's intention.

4. The multi-style transformation apparatus of claim 1, further comprising:
a style intensity adjustment unit configured to set style application intensities for respective segmentation regions,
wherein the style transformation mask generation unit is configured to generate the multi-channel mask based on the segmentation regions and style application intensities for respective segmentation regions.

5. The multi-style transformation apparatus of claim 1, wherein the style transformation mask generation unit is configured to:
generate a multi-channel mask which has a size identical to a size of the content image and in which a value of a channel corresponding to an index of a style set to be applied to each segmentation region is set to ‘1’ and values of remaining channels are set to ‘0’, and
set all channels of segmentation regions that are set for non-transformation to ‘0’.

6. The multi-style transformation apparatus of claim 1, wherein the multi-style transformation model comprises:
an image encoding unit configured to receive the content image and the mask, concatenate the content image and the mask along a channel axis, and then generate a latent image based on a pre-trained deep neural network; and
an image decoding unit configured to receive the latent image and generate a style-transformed image based on the pre-trained deep neural network.

7. A multi-style transformation method, comprising:
segmenting a region, a style of which is to be transformed, in a content image;
generating a multi-channel mask for style application to respective segmentation regions; and
receiving the content image and the multi-channel mask and outputting a multi-style transformed image based on a pre-trained multi-style transformation model implemented as a deep neural network.

8. The multi-style transformation method of claim 7, further comprising:
converting a data format of the content image by converting a size of the content image through an interpolation and sampling technique, by converting integer-type data into real number-type data, or by normalizing a data range to a value falling within a certain range using average and variance.

9. The multi-style transformation method of claim 7, wherein segmenting the region comprises:
outputting segmentation region information in a form of at least one of multiple masks, a multi-channel mask or an RGBA color image, or a combination thereof; and
setting styles for respective segmentation regions according to a user's intention.

10. The multi-style transformation method of claim 7, further comprising:
setting style intensities to set style application intensities for respective segmentation regions,
wherein generating the mask comprises:
generating the multi-channel mask based on the segmentation regions and style application intensities for respective segmentation regions.

11. The multi-style transformation method of claim 7, wherein generating the mask comprises:
generating a multi-channel mask which has a size identical to a size of the content image and in which a value of a channel corresponding to an index of a style set to be applied to each segmentation region is set to ‘1’ and values of remaining channels are set to ‘0’; and
setting all channels of segmentation regions that are set for non-transformation to ‘0’.

12. The multi-style transformation method of claim 7, wherein the multi-style transformation model comprises:
an image encoding unit configured to receive the content image and the mask, concatenate the content image and the mask along a channel axis, and then generate a latent image based on a pre-trained deep neural network; and
an image decoding unit configured to receive the latent image and generate a style-transformed image based on the pre-trained deep neural network.

13. A multi-style transformation training apparatus, comprising:
a training image database configured to store indexed content-style image dataset pairs;
a training data generation unit configured to generate a content patch and a style patch by selecting a content-style image dataset pair from the training image database;
a style transformation mask generation unit configured to generate a multi-channel mask using an index of the selected content-style image dataset pair;
a multi-style transformation model implemented as a deep neural network and configured to receive a content image and the multi-channel mask and output a multi-style transformed image; and
a style transformation error analysis unit configured to analyze error between the multi-style-transformed image generated by the multi-style transformation model and the style patch generated by the training data generation unit,
wherein the multi-style transformation model is trained to minimize error analyzed by the style transformation error analysis unit.

14. The multi-style transformation training apparatus of claim 13, wherein the training data generation unit is configured to perform at least one of normalization or image augmentation, or a combination thereof to a value falling within a specific range on each of a content image and a style image of the content-style image dataset pair selected from the training image database, and thereafter generate a content patch and a style patch by cropping a resulting image in a certain size.

15. The multi-style transformation training apparatus of claim 13, wherein:
a mask image has a size identical to a size of the content patch and includes the number of channels identical to the number (N) of style indices corresponding to content-style image dataset pairs present in the training image database, and
the style transformation mask generation unit generates a mask in which a value of a channel corresponding to an index (n, n=0, . . . , N−1) of the selected content-style image dataset pair is set to ‘1’, and in which values of remaining channels are set to ‘0’.

16. The multi-style transformation training apparatus of claim 15, wherein:
the training data generation unit copies the content patch instead of a style patch depending on a specific probability defined as a non-transformation probability, and sets index information of the content-style image dataset pair to specific code other than n, and
the style transformation mask generation unit sets all channels of a style transformation mask to ‘0’ when the index of the content-style image dataset pair is set to the specific code other than n.

17. The multi-style transformation training apparatus of claim 13, wherein the multi-style transformation model comprises:
an image encoding unit configured to receive the content patch and the mask, concatenate the content patch and the mask along a channel axis, and then generate a latent image based on the deep neural network; and
an image decoding unit configured to receive the latent image and generate a style-transformed image based on the deep neural network.

18. The multi-style transformation training apparatus of claim 17, further comprising:
a multi-resolution image conversion unit configured to generate multi-resolution images, horizontal and vertical sizes of which are reduced at certain rates by applying a down-sampling or image interpolation technique to the style patch generated by the training data generation unit,
wherein the image decoding unit receives an encoded latent image and further generates and outputs a multi-resolution feature map, and
wherein the style transformation error analysis unit calculates encoding image error through a weighted sum of errors between multi-resolution images received from the multi-resolution image conversion unit and the multi-resolution feature map received from the image decoding unit.

19. The multi-style transformation training apparatus of claim 17, wherein:
the image decoding unit receives an encoded latent image and further generates and outputs a restored mask, and
the style transformation error analysis unit analyzes error between the mask received from the style transformation mask generation unit and a mask restored by the image decoding unit.

20. The multi-style transformation training apparatus of claim 17, wherein the style transformation error analysis unit calculates generative adversarial error by inputting a style-transformed image output from the image decoding unit to a discriminator in a generative adversarial error analysis unit.
